(19) United States
(12) Patent Application Publication
(10) Pub. No.: US 2010/0256992 A1
(43) Pub. Date: Oct. 7, 2010

(54) WEB-AND MOBILE-BASED EMERGENCY HEALTH REGISTRY SYSTEM AND METHOD

(75) Inventors: DAVID NOAH ROBERTS, Tulsa, OK (US); CHRIS ZENTHOEFER, Bixby, OK (US); BRAD ALLEN SPEAR, Tulsa, OK (US); ELANA BETH PERDECK, Cooper City, FL (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: DOCVIA, LLC, Tulsa, OK (US)

(21) Appl. No.: 12/718,258

(22) Filed: Mar. 5, 2010

Related U.S. Application Data
(60) Provisional application No. 61/166,140, filed on Apr. 2, 2009.

(51) Int. Cl. G06Q 50/00; A44C 3/00; G01M 17/007; G06F 19/00; G06F 15/16

(52) U.S. Cl. 705/3; 40/1.5; 701/33; 709/219

(57) ABSTRACT

There is provided herein a system and method for allowing an individual to preauthorize that certain of his or her vital information can be made available to healthcare personnel in an emergency. The instant invention will preferably allow the individual to preauthorize release of this information by registration via the Internet. In the preferred embodiment, each registrant will be issued an alphanumeric PIN (“personal identification number”) that can be used by the emergency responder to request the patient's data and to notify the patient's contacts when the patient is being transported by ambulance. Preferably, the instant invention will be Internet or otherwise wirelessly based so that the emergency responder can obtain the information at the accident site.

This application claims the benefit of U.S. Provisional Patent Application Ser. No. 61/166,140 filed on Apr. 2, 2009, and incorporates said provisional application by reference into this document as if fully set out at this point.

### FIELD OF THE INVENTION

The present invention relates generally to the field of health care and more specifically to systems and methods for granting emergency medical service and other healthcare providers with limited authorized access to a patient's health information in the event of an emergency.

### BACKGROUND OF THE INVENTION

It goes without saying that many individuals who require emergency medical treatment (e.g., because of an automobile accident, home accident, chronic medical conditions, etc.) have complex medical histories that, if that information were available at the time to the emergency responder, could be put to good use.

More particularly, information that describes preexisting medical conditions, drugs currently taken and their dosages, past emergency episodes and their treatments, etc., are examples of the sorts of information that could significantly alter what would otherwise be a standard response to an emergency situation. In fact, lack of access to the information may be detrimental, if not catastrophic, to the person who is in need of assistance. Although some of this history might be obtainable from the individual (if he or she is conscious), there is always a risk that something will be forgotten or misremembered.

On the other hand, emergency medical service (“EMS”) personnel or other caregivers typically do not want or need the full medical history of the patient. Even in the event that the patient has a very complex history, the EMS provider will likely only be interested in a small subset of that history. Thus, making available the entire medical history of a patient in an emergency situation may very well be counter productive, in that that the time spent looking through multiple pages of patient medical history looking for a few key items of information can unnecessarily delay treatment.

Of course, access to a patient's medical information is generally not made available to the public, where the “public” includes, among others, emergency responders. Privacy issues have always dictated against making this sort of information generally available and these and other concerns have been codified in state and local statutes such as the 1996 federal HIPAA (“Health Insurance Portability and Accounting Act”) legislation.

Finally, in most cases the emergency victim would want the emergency responder (and similar healthcare providers) to have access to at least a portion of their otherwise private medical data in times of need. However, absent explicit consent by the patient such information would not be available.

Thus, what is needed is a system and method that allows an accident victim to preauthorize certain healthcare providers to rapidly access at least a portion of that victim's medical history in an emergency. Further, that information would need to be available at the site of the accident if it is to be of any real use. Still further, the system would need to comply at least with current privacy-related statutes as they pertain to medical data. Finally, the system would need to provide protection both for the individual and for the entity that releases the medical information.

Heretofore, as is well known in the medical arts, there has been a need for an invention to address and solve the above-described problems. Accordingly, it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

There is provided herein a system and method for allowing an individual to preauthorize that certain of his or her medical information be made available to healthcare personnel in an emergency. The instant invention will preferably allow the individual to preauthorize release of this information in an emergency by registration via the Internet. In the preferred embodiment, each registrant will be issued a PIN (“personal identification number”) or other code that can be used by the emergency responder to request the patient's data. Preferably, the instant invention will be Internet or otherwise wirelessly based so that the emergency responder can obtain the information at the accident site.

Medical data regarding a person in need of assistance and who is unresponsive or uncooperative will be provided to an emergency responder in response to a query that is originated by the responder. The user's medical data will preferably be obtained from a health care computer system, a medical data collector, and/or an emergency responder system while the emergency responder is in route to or assisting the person. Further, the medical data will preferably be a subset of the individual's medical history which contains information of most use to an EMS or other emergency care giver.

In one implementation, a process for generating emergency response data may include receiving an emergency request from a person in need of assistance, having the responding EMS personnel obtain identifying information from the patient (preferably in the form of a personal identification number or “PIN” as it is conventionally abbreviated), establishing a secure connection with a central server or other data repository, transmitting the PIN to the server, obtaining medical data in return that has been previously provided by the patient, and treating the patient according to the information so received. The identifying information will preferably be sent to, and the medical data received from, an emergency responder interface device using a wireless communication network (e.g., a cell phone network, WiFi, etc.).

In another embodiment, there is provided a system for generating emergency response data may include an emergency responder system operable to receive an emergency request for a person in need of assistance, request medical data regarding the person in need of assistance, and send the medical data to an emergency responder interface device.

In some preferred embodiments, the patient's PIN will be located on a sticker that can be affixed to, for example, the back of the user's drivers license or other identification card, printed on a key fob, printed on a plastic card which is sized similar to that of a credit card, printed on an item of clothing or equipment (e.g., wrist band, helmet, etc.), worn as an item of jewelry (e.g., imprinted on a bracelet, necklace, ring, etc.), printed or affixed mechanically to an item of clothing, etc. In the text that follows, each of the foregoing (e.g., sticker, key fob, etc.) shall be referred to as a communications modality (or just “modality”) for communicating the PIN to a caregiver. Additionally, the text that follows will refer to the modality as being worn or carried. However, it should be understood that, no matter which term is used, the only requirement is that the modality and its associated PIN be available to the caregiver in an emergency. Finally, although the PIN will often be described as being printed onto an item, those of ordinary skill in the art will recognized that there are many other means of placing the PIN on an item (e.g., embossing, inscribing, etching, engraving, painting, drawing, etc.). Thus, in the text that follows the words “print,” “imprint”, etc., should be interpreted in their broadest sense to include any mechanism or method of placing a visible code on a modality.

The various implementations may have one or more differing features. For example, the on-site time of emergency responders may be reduced, which can be beneficial to the person in need of assistance and to the emergency responder system. As another example, emergency responders may be able to quickly and reliably access patient data via multiple unique modalities (e.g., telephone, PDA, laptop, etc.). As an additional example, medical data may be generated, managed, and controlled by patients. Thus, patients may maintain control of their medical data.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 depicts the general environment of the instant invention.

FIGS. 2A and 2B illustrate the sort of identifying information and associated materials (e.g., key fobs, stickers, etc.) that would be suitable for identifying a customer/patient.

FIG. 3 contains a flow chart that illustrates an operating logic suitable for use with the user/patient component of the instant invention.

FIG. 4 contains a flow chart that illustrates an operating logic suitable for use with the caregiver component of the instant invention.

FIG. 5 illustrates another preferred embodiment wherein a device containing the user's PIN is attached to an item of sporting apparel such as a football jersey.

FIG. 6 contains a close up/top view of the embodiment of FIG. 5.

FIG. 7 contains a schematic illustration of a cross sectional view of the embodiment of FIG. 5.

FIG. 8 illustrates the bottom side of embodiment of FIG. 5.

FIG. 9 contains a schematic illustration of an operating logic that would be suitable for use with the automobile-based embodiment of the instant invention.

FIG. 10 contains a flowchart that illustrates the preferred steps that would take place in the event that an automobile accident occurs

FIG. 11 contains a schematic illustration of the instant invention as it might appear if displayed on an automobile display device.

FIG. 12 contains the illustration of FIG. 11 but modified to reflect a preferred way of assigning individual names to seats in the automobile using a “drag and drop” paradigm.

### DESCRIPTION OF THE PREFERRED EMBODIMENTS

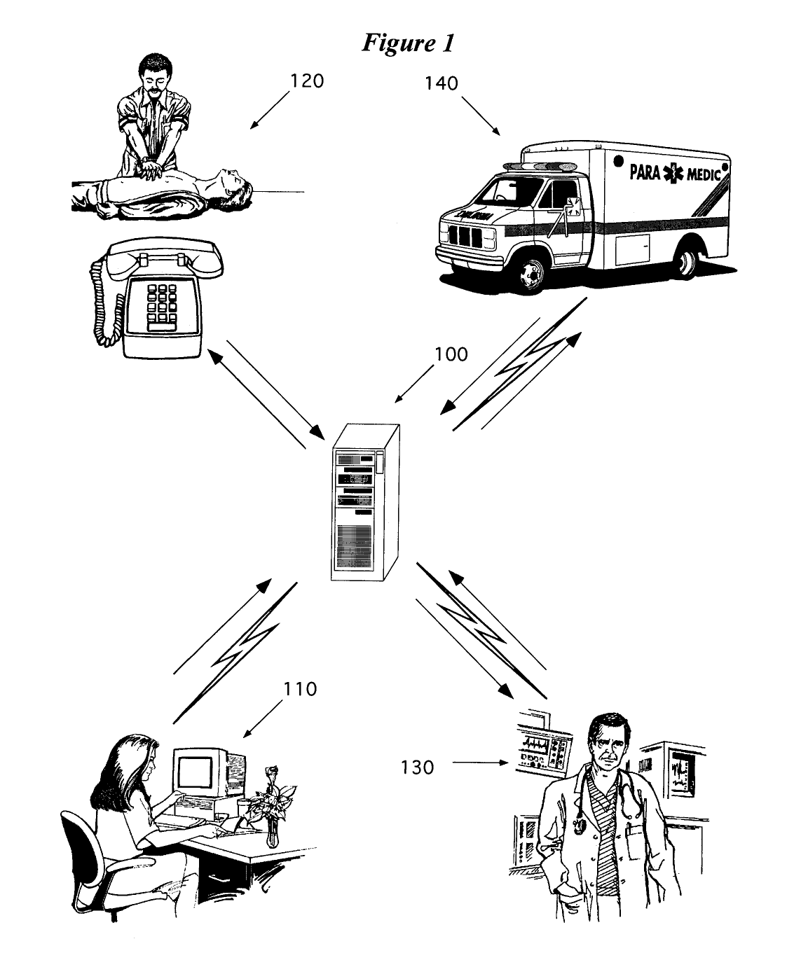

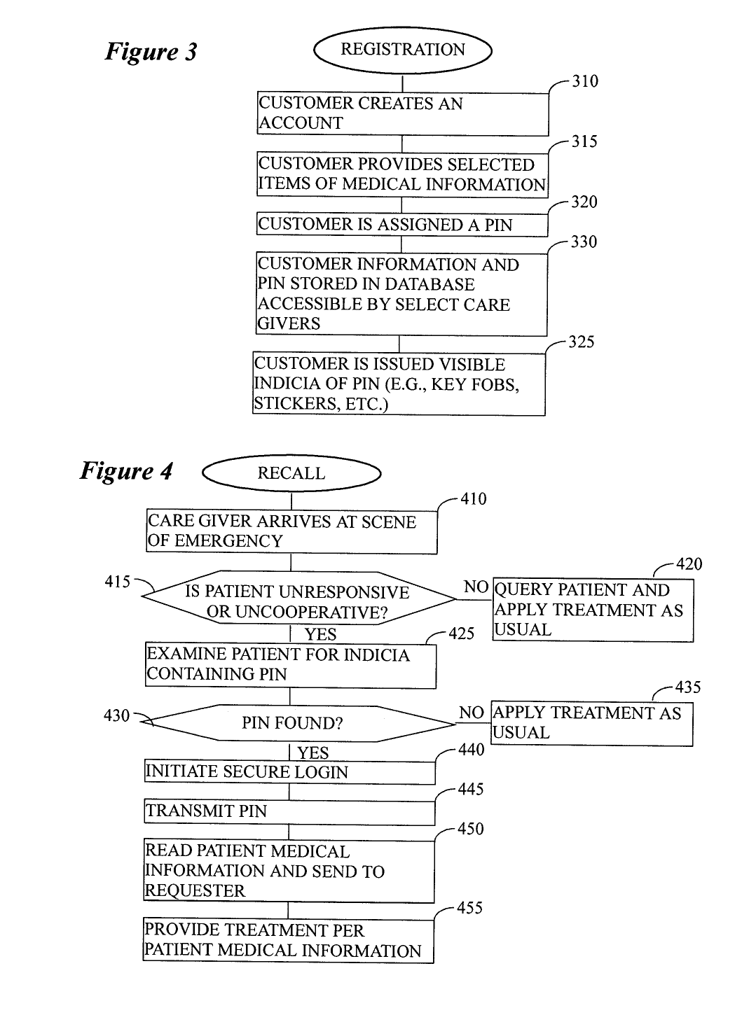

Referring now to the drawings, wherein the reference numerals indicate the same parts throughout the several views, there is provided a system and method for allowing a user to provide selected information to an emergency medical worker in times of an emergency. According to a preferred embodiment of the instant invention, and as is broadly indicated in FIG. 1, the instant invention will preferably start with a user 110 logging into a secure web interface of the instant invention and establishing an account (step 310 of FIG. 3). In some embodiments, the user might be entering information for himself or herself. In other instances, the user might be submitting information on behalf of another (e.g., a child, an elderly relative, a spouse, etc.). In either case, select information as described below will be obtained from the user (step 315).

The information that is submitted by the user 110 will preferably be stored in a secure central server 100 where it can be accessed in times of need by certain medical professions and caregivers as is discussed hereinafter (step 330). Those of ordinary skill in the art will recognize that although only a single computer 100 is illustrated in FIG. 1, components of the instant invention might reside on multiple computers that are in close physical proximity or distributed across the world and are interconnected via the Internet or via a similar communications network. Further, in some instances one computer system might be responsible for in-taking customer information and another for dispensing it in an emergency. However, for purposes of specificity in the text that follows, “central server” will be used to refer to the system or systems that are responsible for collecting and distributing patient data according to the methods of the instant invention. The information so obtained will preferably be stored in a central server 100 where it can be accessed by EMS personnel 140, emergency room doctors 130, and other caregivers 120 in times of emergency.

In the preferred embodiment, various items of medical data will be solicited from the user via a web interface that has preferably been developed for that purpose. Preferably, during the login session the user 110 will be prompted to enter specific sorts of information (“patient information”, hereinafter) such as the following:
Patient name,
Contract information (e.g., home and/or mobile phone number, address, etc.),
Date of birth, gender, etc.,
Insurance carrier (if any),
Primary care provider,
Allergies,
Medications currently being taken,
A short list of medical conditions that would be most relevant in an emergency care situation, e.g., whether or not the customer has hypertension, diabetes, asthma, a history of heart attacks or heart failure, and,
Emergency contact information.
   As was indicated previously, the “Name” parameter field might either be the user who created the login or the name of another individual for whom the information is being submitted. In either case, it is the patient's name that is to be placed in this field. The last item of information above, i.e., contact information, would be especially important in the event that the user is entering information for a child.

It should be noted and remembered that an important aspect of the instant invention is that the patient information is not intended to encompass the entire medical history of the patient. Instead, the information that is solicited is a minimal subset of that information that would be most useful to caregivers in emergency or other situations where the patient in unable or unwilling to communicate (e.g., because the patient is unconscious, delirious, confused, too young, etc.). Said another way, the information the patient will be asked to provide has intentionally been kept to a minimum. This has been done to improve the chances of a patient's full compliance and also to reduce the amount of information that must be processed by the emergency care provider. Also, note that the patient controls how much information is entered into the form and, thus, how much information will be available to the subsequent reader. As a consequence, and unlike other systems, the instant invention allows a patient to edit/screen/control the medical data that is presented to the emergency worker and, thus, will include only those details that the patient feels comfortable sharing with a caregiver in an emergency situation. Further, in some preferred embodiments the user will be given the option of entering information and then allowing only a subset of that information to be visible by the caregiver in an emergency or, alternatively, visible by some sorts of caregivers (e.g., emergency room doctors) but not others. The goal is to provide the user as much control over the dissemination of this information as the user desires.

Note that the user will preferably be able to edit/revise his or her medical data to reflect their changing circumstances. In some preferred embodiments, the user will be periodically reminded (e.g., via e-mail) to do this.

Returning now to a further discussion of the information that is preferably solicited by the instant invention, preferably, one or more emergency contacts will be identified (and, preferably, subsequently confirmed). Emergency contacts are those individuals who should be contacted electronically in the event of an emergency. In the preferred arrangement, the emergency contact will be reachable by email and/or telephone text messaging. Preferably, after the patient provides the contact information, that information will be verified by sending an email or SMS to the designated emergency contact at the address (or phone number, etc.) provided by the customer. The contact will then be given the option of accepting the designation as emergency contact or declining it. If the contact accepts, a provision will preferably be made for them to reply electronically to signify that fact (e.g., “Click here to agree to be the emergency contact for Mr. Jones”). Similarly, if the emergency contact wishes to decline this responsibility, he or she might do that either by clicking (or otherwise selecting) a pre-designated reply in the negative or by failing to reply at all. In either case, the acceptance or declination of the nomination as emergency contact will be communicated to the registered patient.

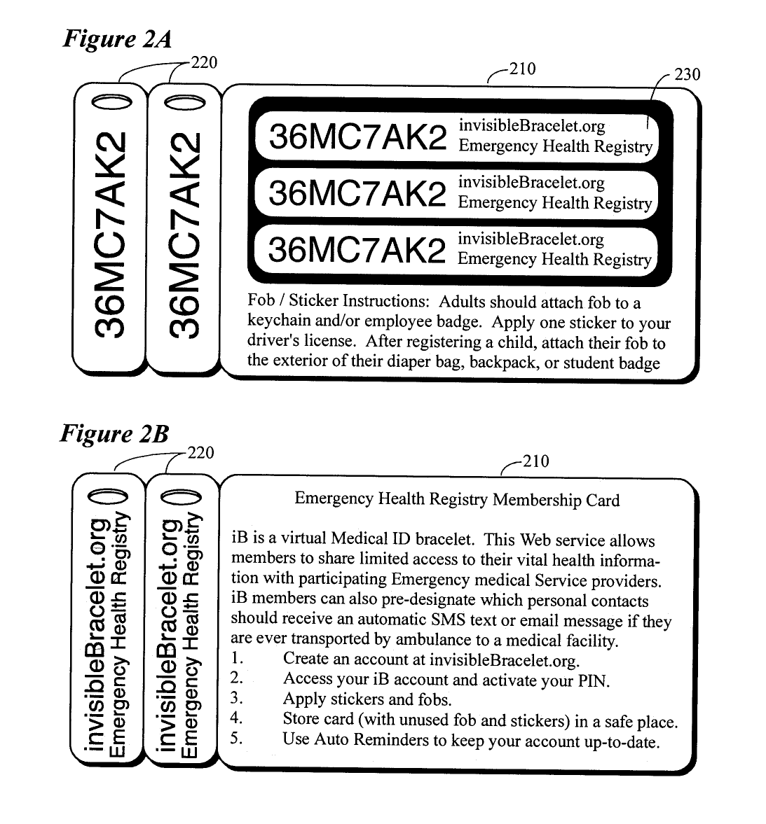

The user will preferably next provide billing information, credit card type, etc. Upon receipt by the instant invention this information, the patient will preferably be registered according to the instant system and key fobs and/or stickers (FIGS. 2A and 2B) will preferably be mailed to the participant as is described below.

After the user's information has been obtained, a unique identifier (e.g., a PIN) will be selected and presented to the user (step 320). Although this identifier will be referred to as a “PIN” herein, obviously it need not actually be a “number” but could include numbers, letters, symbols, etc. All that is required is that the PIN be unique for each individual. Additionally, and preferably, one or more tags or other modalities of communicating the PIN will then be sent to the user (step 325) so that they can become a part of the user's information set that accompanies him or her everywhere. That is, the identifier will preferably be designed to be carried, worn, or otherwise kept close at hand.

FIGS. 2A and 2B contain front and back views of the sort of I.D. card that might be distributed to users who register with the instant inventive system. As can be seen in FIG. 2A, the body 210 of the preferred I.D. card contains a plurality of stickers 230 that are intended to be removed and affixed to the back of the user's driver's license, backpack, employee or student I.D. card, biking helmet, or any other article of equipment or clothing that the client might be carrying or wearing at the time of an emergency. Additionally, and preferably, the I.D. card will contain one or more separable key fobs 220 that contain the PIN and are designed to be attached to the user's key ring. The patient will then preferably be instructed to attach one of the fobs to a keychain. Additionally, stickers will be provided that are to be attached to, for example, the back of the user's driver's license, the inside of a biking helmet,

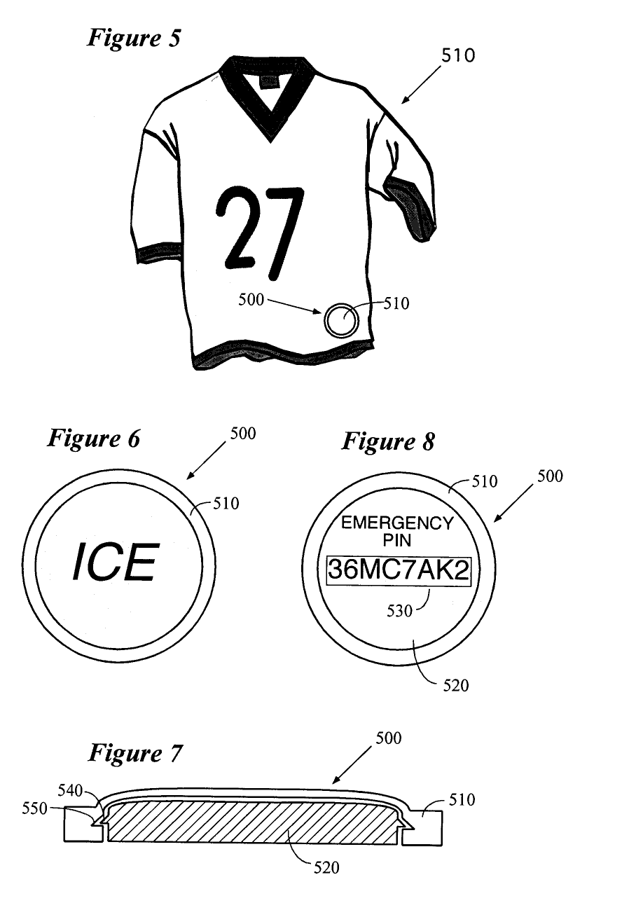

According to still another preferred embodiment, and as is illustrated in FIGS. 5 through 8, there is provided an invention substantially as described above, but wherein the PIN is affixed to a user's article of clothing by way of a detachable badge 500. As is illustrated in FIG. 5, in a preferred embodiment a detachable badge 500 will be removably affixed to clothing such as a sports jersey 510. Those of ordinary skill in the art will recognize that although the badge 500 will preferably be made to be removable, it might also be permanently attached. Whether or not the badge 500 is removable is immaterial to the operation of the instant invention.

FIGS. 6-8 contain additional details of this embodiment. FIG. 6 illustrates the outer surface 510 of the instant badge 500. The “ICE” (“in case of emergency”) logo is outward facing and serves as an indicator the EMS or other medical personnel that the badge 500 contains information related to the user's medical history.

On the reverse side 520 of the badge 500 is the emergency PIN 530 which is intended to be normally hidden from view. However, when a caregiver examines the wearer of the badge 500, the PIN 530 can be readily identified.

Finally, FIG. 7 contains a cross sectional view of a preferred embodiment of the badge 500. As can be seen in that figure, there is space between inner/enclosed member 520 and outer member 510. In the preferred arrangement, the fabric of the shire 510 will be placed between the inner 520 and outer 510 member and the two members snapped together. As is indicated in this figure, the inner member 520 will preferably be provided with a latch ring 540 that is designed to mate with grove 550, thereby removably locking the badge 500 to the shirt 510.

In an emergency situation (i.e., after an emergency event), the responder (e.g., EMS personnel) will travel to the patient's side (step 410 of FIG. 4) and, if the victim is unresponsive or uncooperative (the “YES” branch of decision item 415) the caregiver will examine the patient for indicia of a PIN (step 425). Of course, if the patient is conscious and responsive the normal treatment protocols would be followed which would include querying the patient as to his or her condition, etc. (step 420). That being said, depending on the state of mind of the patient, the care giver may wish to confirm any information received from the patient by checking with the server 100 of the instant invention.

If the PIN is not located (the “NO” branch of decision item 430) somewhere on the patient's person, the patient will be treated as is customary (step 435). On the other hand, if a PIN is located (the “YES” branch), the caregiver will establish a secure connection (step 440) to the server 100 of the instant invention. Preferably, the instant invention will communicate f via a secure link such as “HTTPS”. Further, and preferably, this will be a wireless connection (e.g., via telephone or WiFi) but it could also be wired if, for example, the patient is in the emergency room of a hospital. Also, and preferably, each emergency responder will have a unique login and password.

After the secure connection has been established, the patient's PIN will be provided to the server 100 (step 445). Preferably, an on-screen field will be provided that allows the caregiver to enter the I.D. code (e.g., PIN) obtained from the sticker or key fob.

After login validation and receipt of the patient's PIN, the server 100 will read the stored information corresponding to the PIN and send the medical data previously provided by the patient to the requestor's PDA, laptop, cell phone, desktop computer, etc. (step 450), thereby providing potentially life saving information to the caregiver. In the preferred arrangement, any device that is capable of running a web browser or similar program that can communicate over the Internet and through which the user can establish a secure communication channel would be suitable. Of course, after receiving the patient's information the caregiver will then provide treatment consistent with the medical information that has been previously provided by the patient.

According to another preferred aspect of the instant invention, there is provided a system and method for integrating the instant invention into the crash detection function of a modern automobile. For example, systems such as ON STAR® and other similar systems are designed to automatically transmit vehicle information to a central monitoring facility in the event of an accident. In a preferred aspect of the instant invention, that transmission will also include a PIN that will allow the recipient of the crash notification to notify EMS or other caregivers who might be on the way to the scene of the accident, of pertinent medical history items of the vehicle occupant who may have been injured in the crash.

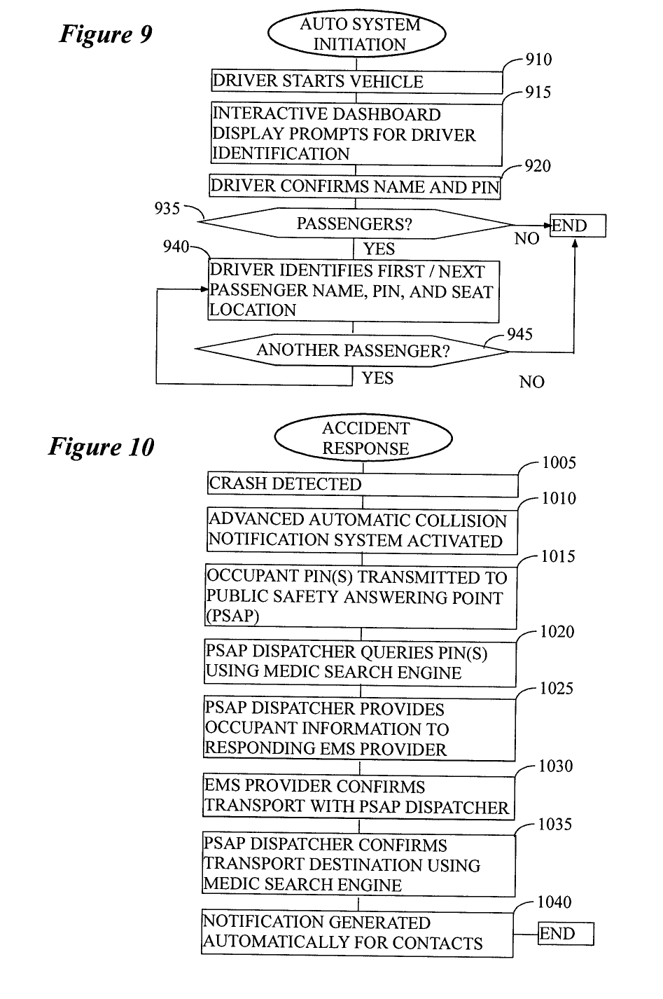

FIG. 9 illustrates one preferred method of entering passenger information into the computer that is onboard within the automobile so that such information may be transmitted automatically in an emergency.

As a first preferred step, the driver will start the vehicle (step 910) as is conventionally done. Of course, those of ordinary skill in the art will recognize that the car might merely be operating on battery power and need not actually be started. However, it is important that one or more of the onboard automobile computers be activated no matter how that needs to be done for a particular make and model of automobile.

According to a next preferred step 915, the instant invention will prompt the driver for his or her identification information, which information will preferably have previously been entered into the automobile computer as described below. Preferably, the identification of and interaction with the driver will take place on the video display screen of the automobile.

In the preferred arrangement, the information related to the names and corresponding PINs of the regular occupants of the vehicle will be entered only once and thereafter will be stored onboard the automobile in an internal hard disk, within nonvolatile memory, etc. Preferably, the driver or another adult will have previously registered himself or herself and the other family members via the Internet as has been described previously. The PIN numbers that are returned by the instant invention will then be entered into the automobile computer system and stored therein. That step might or might not be followed by verification step which is designed to confirm the central server that each PIN has been entered correctly. Subsequently, and as is described in greater detail below, each time the automobile is started the list of stored passengers will preferably be presented to the driver to make it easier to pair up seat positions and registered riders.

Continuing with the discussion of FIG. 9, after the driver confirms his or her name and PIN (step 920), the automobile computer will next determine whether there are any passengers in the car. This might be done in many ways, however, in the preferred embodiment seat sensors, which are almost universally used for purposes of encouraging seat belt use, will be used to determine the number of non-driving passengers in the automobile. As is indicated in FIG. 9, if there are no passengers (i.e., the right branch of decision item 935), this aspect of the instant invention will terminate. On the other hand, if there are passengers (i.e., the “YES” branch of decision item 935), the driver will identify the first or next passenger name, PIN and seat location (step 940). The instant invention will preferably continue until all of the seats that are believed to contain passengers have been assigned a passenger name and PIN, if that is possible. If all the passengers have been processed (i.e., the “NO” branch of decision item 945), this aspect of the instant invention will terminate. On the other hand, if there are more passengers, the instant invention will preferably return to step 940 and allow the driver to identify the remaining passengers. Note that, although in the preferred embodiment every passenger will be identified as to location and PIN, it is anticipated that in some circumstances, it might be desirable to allow the driver to skip one or more seat positions if, for example, a sack of groceries is sitting on the seat, the passenger is not a family or other member for which a PIN has been assigned, etc.

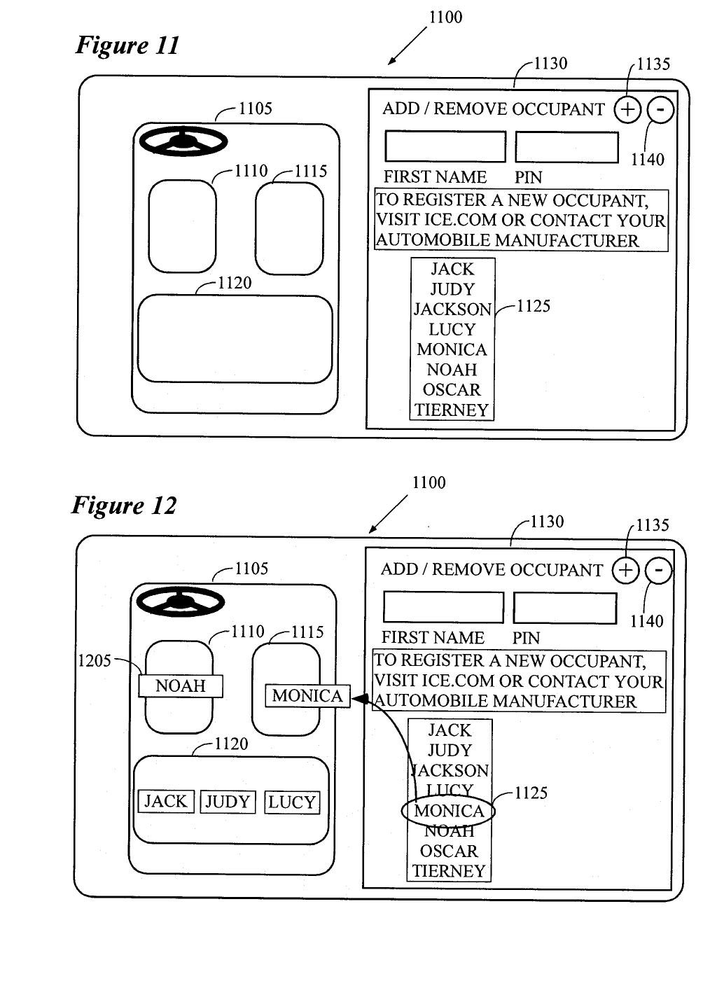

FIG. 11 illustrates a preferred screen display signal for use with the instant invention when the driver is performing the steps of FIG. 9. In a preferred arrangement, the automobile display screen 1100 will contain at least two fields. On the left side of the display 1100 is a field that contains a schematic representation of the inside of the automobile 1105 which icons that are representative of driver's seat 1110, front passenger seat 1115, and back seat 1120, respectively. Of course, larger SUVs and other vehicles may have more than (or fewer than) two rows of seats, in which case the schematic display of the interior of the car 1105 will preferably be modified accordingly. The second field 1130 of the display 1100 will preferably be used to interact with the driver as is discussed below.

As is generally illustrated in this figure, in the preferred arrangement when the instant invention is activated, a list of individuals for whom PINS have been previously entered will preferably be displayed. The list 1125 will like be comprised of family members or friends of the family for whom such medical information would be available. As is generally indicated in this figure, in order to add or remove an occupant from the list of names with associated PINS, a “plus” control 1135 and a “minus” control 1140 will preferably be provided. The driver will be able to type a name into the first name field and add a PIN which, upon activating the “plus” onscreen icon 1135, would be added to the listing 1125 of registered users 1125. Similarly, if a name is selected in the listing 1125 and the “minus” icon 1140 is activated, preferably that name will be removed from the list of registered occupants, possibly only after a confirmation is required from the user.

Turning next to FIG. 12, in a preferred arrangement, the driver or a front seat passenger will select a name from the listing of registered individuals 1125 and “drag and drop” that name to a seat location. As is indicated in this figure, “Noah” has been placed on the icon representing the driver's seat 1110, thereby indicating that he is the driver of the car. In the backseat 1120, three individuals “Jack,” “Judy,” and “Lucy” have been placed in the backseat at positions roughly corresponding to the automobile's seatbelt locations. As is indicated in. FIG. 12, “Monica” has been chosen from the registered individual listing 1125 and is being moved to the front passenger seat 1115, where it will be dropped to indicate that this individual is riding in the front seat.

FIG. 10 contains a schematic representation of how the instant invention would operate in practice if a crash is detected. If a crash is detected (step 1005), as has been mentioned previously, certain automobiles have a built-in collision notification system that activates when a crash is detected. A crash might be sensed in many different ways but in some instances activation of the air bags, accelerometers that register unusual deceleration, sensors that measure the deformation of the frame, etc., might be utilized to detect such an event. Preferably, the instant invention will operate in conjunction with such a system that is already present in an automobile, although those of ordinary skill in the art will recognize how an automobile that does not have this sort of feature might be modified to work with the instant invention.

Following the occurrence of a crash which is severe enough to activate the notification system, notice of the event will typically wirelessly transmit information from the automobile to a central receiving station. That information might include the type of damage to the automobile, any sensor data that is available on the automobile (e.g., accelerometers, GPS location, etc.). Additionally, the instant invention will operate together with the identification system to transmit to the public safety answering point (“PSAP”) the occupant PINs and their seat locations in the automobile.

The PSAP dispatcher will then receive the PIN(s) and retrieve the patient name and medical information using the central server of the instant invention (step 1020) as has been discussed previously.

The PSAP dispatcher will preferably provide occupant information to the responding EMS provider (step 1025). This information will preferably be communicated via a wireless connection and will utilize cell phone, short wave, etc. The EMS provider will then arrive at the scene and treat the patient according to the medical information provided by the PSAP dispatcher. Additionally, the EMS provider will communicate again with the PSAP dispatcher to communicate any transport arrangements that have been made for the patient (step 1030).

The PSAP dispatcher will then confirm receipt of the transportation destination of the patient and will communicate that information to the instant invention at its central server (step 1035). Finally, and as has been discussed previously, the instant invention will then preferably generate an automatic notification to the previously designated emergency contact of the patient to inform that individual that the patient has been injured and is being transported to a medical facility.

### CONCLUSIONS

Among the many unique aspects of the instant invention, it should be noted that, in this case, the patient or other user selects and controls how much (or little) information the medical personnel will be able to see. Other systems that seek to do similar things typically provide the entirety of a patient's medical record to the emergency caregiver. In the instant invention, though, the patient is able to self-edit and control the information that is visible to caregiver.

Note further that it is an object of the instant invention to present information in a way that is most useful to the emergency caregiver. Preferably, this means that the information that is solicited from the user—and is presented to the emergency caregiver—is information of the sort that is most critical to treatment. Indeed, it is preferable that the amount of information that is solicited from the user be kept to a minimum to increase the likelihood that the customer will comply with the request for this information, and also to make it easier for the caregiver to find the information that is really needed.

Another advantage of the instant invention is that the patient provides his or her own medical data. It is not drawn from the records of hospitals, primary care physicians, etc. This is important for two reasons. First, a patient always has a right to disclose his or her own personal medical information to a third party, thus, privacy concerns with respect to obtaining the patient's medical information are not implicated. Second, according to the instant invention, the patent can provide as much or as little information as he or she desires to be seen in the event of an emergency, thereby allowing the patient to filter the data that will be accessible to an emergency care worker. This would be unlike a situation where a patient gives a general release to allow third parties to look at their entire medical record.

Still another advantage of the instant invention is that the patient will preferably be responsible for maintaining the data that is kept online, rather than requiring the institution(s) that might otherwise have such information to do that.

Further, it should be noted that the instant invention does not require the sort of automated sweeping (i.e., “reading”) of the patient's hospital and/or personal physician's records that is utilized by other inventions that seek to accomplish a similar goal.

Finally, the instant invention is certainly suitable for emergencies that might occur in the home, while traveling locally, at sporting events, etc. However, since the instant invention is potentially world wide in its applicability, travelers (whether abroad or in this country) who experience emergency situations while traveling in automobiles, on planes, trains, ships, busses, etc., could potentially benefit from the instant invention so long as the caregiver can gain access the Internet or can connect to the server(s) of the instant invention via some other communications medium (e.g., via telephone).

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method of determining a treatment for a patient after an emergency event, comprising the steps of:
(a) accessing a central server by a user via a secure Internet connection;
(b) providing a portion of the patient's medical information to said central server via said secure Internet connection;
(c) obtaining a PIN applicable to said patient, said PIN being unique to said patient;
(d) selecting a modality for the PIN, said modality having at least a representation of said PIN imprinted thereon;
(e) carrying said modality by the patient; and,
(f) after the emergency event,
(f1) obtaining by a caregiver said modality,
(f2) obtaining said PIN from said modality,
(f3) providing said PIN to said central server, and,
(f4) obtaining from said central server said portion of the patient's medical information; and,
(g) treating the patient according to said obtained medical information.

2. The method according to claim 1, wherein the user and the patient are a same person.

3. The method according to claim 1, wherein said portion of the patient's medical information is selected from a group consisting of a listing of allergies, a listing of medications being taken, an indication as to whether the patient has hypertension, an indication as to whether the patient has diabetes, an indication as to whether the patient has a history of heart attack, and, an indication as to whether the patient has a history of heart failure.

4. The method according to claim 1, wherein step (f3) comprises the step of
(i) providing said PIN to said central server via a wireless connection.

5. The method according to claim 1, wherein step (f3) comprises the step of:
(i) establishing a secure Internet connection to said central server, and,
(ii) transmitting said PIN to said central server via said secure Internet connection.

6. The method according to claim 5, wherein step (f4) comprises the step of:
(f4) obtaining from said central server said portion of the patient's medical information via said secure Internet connection.

7. The method according to claim 1, wherein step (b) comprises the steps of:
(i) providing a portion of the patient's medical information to said central server via said secure Internet connection, and,
(ii) providing at least one emergency contact to said central server, and wherein step (g) comprises the steps of:
(g1) treating the patient according to said obtained medical information,
(g2) transporting the patient to a care facility,
(g3) notifying said central server of the care facility,
(g4) automatically transmitting from said central server to at least one of said at least one emergency contacts a notification that the patient is being transmitted to the care facility.

8. The method according to claim 1, wherein said modality for the PIN is a removable badge positionable to be affixed to an item of clothing worn by the patient, said badge having a representation of said PIN imprinted thereon.

9. A method of determining a treatment for a patient after an emergency event, comprising the steps of:
(a) prior to the emergency event,
(a1) accessing a central server by a user,
(a2) establishing an account on said central server, said account being associated with the patient,
(a3) transmitting a portion of a medical history of the patient to said central server, said portion of the medical history of the patient being chosen to be useful to a caregiver in an emergency,
(a4) issuing a PIN applicable to said patient,
(a5) selecting at least one modality for the PIN, said at least one modality having at least a representation of said PIN imprinted thereon, and,
(a6) carrying said modality by the patient; and,
(b) after the emergency event,
(b1) obtaining by the caregiver said PIN from said modality,
(b2) transmitting said PIN to said central server, and,
(b3) obtaining from said central server said portion of the medical history of the patient; and,
(c) treating the patient according to said obtained portion of the medical history of the patient.

10. The method according to claim 9, wherein the user and the patient are a same person.

11. The method according to claim 9, wherein said portion of the patient's medical history is selected from a group consisting of a listing of allergies, a listing of medications being taken, an indication as to whether the patient has hypertension, an indication as to whether the patient has diabetes, an indication as to whether the patient has a history of heart attack, and, an indication as to whether the patient has a history of heart failure.

12. The method according to claim 9, wherein step (b2) comprises the step of:
(i) transmitting said PIN to said central server via a wireless connection.

13. The method according to claim 1, wherein step (b2) comprises the step of:
(i) establishing a secure Internet connection to said central server, and,
(ii) transmitting said PIN to said central server via said secure Internet connection.

14. The method according to claim 13, wherein step (b3) comprises the step of:
(f4) obtaining from said central server said portion of the patient's medical information via said secure Internet connection.

15. The method according to claim 9, wherein said modality for the PIN is a removable badge positionable to be affixed to an item of clothing worn by the patient, said badge having a representation of said PIN imprinted thereon.

16. A method of determining a treatment for a patient after an accident in an automobile having a crash detection system, comprising the steps of
(a) accessing a central server by a user;
(b) establishing an account on said central server, said account being associated with the patient;
(c) transmitting a portion of a medical history of the patient to said central server, said transmitted portion of a medical history being chosen to be useful to a caregiver in an emergency;
(d) issuing a PIN applicable to said patient;
(e) communicating said PIN to the automobile;
(f) within said automobile, associating said PIN with the patient;
(g) after the accident,
(g1) detecting the accident within the automobile using the crash detection system,
(g2) automatically transmitting a notice of the accident from the automobile to a receiving station,
(g3) transmitting a signal representative of the accident to a caregiver,
(g4) if the patient is not a passenger within the automobile, treating the patient by the caregiver;
(g5) if the patient is a passenger within the automobile,
(i) automatically transmitting at least said PIN of the patient from the automobile to the receiving station,
(ii) transmitting said PIN from the receiving station to the central server,
(iii) obtaining from said central server said portion of the medical history of the patient, and,
(v) transmitting from said central server to the caregiver a representation of said portion of the medical history of the patient, and,
(c) treating the patient by the caregiver according to said obtained portion of the medical history of the patient.

17. The method according to claim 16, wherein the user and the patient are a same person.

18. The method according to claim 16, wherein said portion of the patient's medical history is selected from a group consisting of a listing of allergies, a listing of medications being taken, an indication as to whether the patient has hypertension, an indication as to whether the patient has diabetes, an indication as to whether the patient has a history of heart attack, and, an indication as to whether the patient has a history of heart failure.
